(19) United States
(12) Patent Application Publication
(10) Pub. No.: US 2026/0336349 A1
(43) Pub. Date: Oct. 29, 2026

(54) SUSPENSION CONTROL SYSTEM AND SUSPENSION CONTROL METHOD

(71) Applicants: HONDA MOTOR CO., LTD., Tokyo (JP); HITACHI ASTEMO, LTD., Ibaraki (JP)

(72) Inventors: Kazuya Konada, Tokyo (JP); Ryosuke Yamazaki, Tokyo (JP); Takashi Yanagi, Tokyo (JP); Yoshifumi Kawasaki, Ibaraki (JP); Yuki Shinotsuka, Ibaraki (JP); Ryusuke Hirao, Ibaraki (JP)

(21) Appl. No.: 19/107,847

(22) PCT Filed: Aug. 25, 2023
(86) PCT No.: PCT/JP2023/030760

§ 371 Date: Feb. 28, 2025

(30) Foreign Application Priority Data
Sep. 5, 2022 (JP) 2022-140581

(51) Int. Cl. B60G 17/019; B60G 17/0165

(52) U.S. Cl. CPC B60G 17/019; B60G 17/0165; B60G 2400/204; B60G 2400/252; B60G 2400/52; B60G 2400/821; B60G 2500/30; B60G 2600/182

(57) ABSTRACT

A suspension control system includes: a road surface distance detector to use at least one distance sensor mounted on a vehicle body to detect a distance to a road surface from the distance sensor to at least one point on the road surface through which a wheel passes; an average road surface displacement calculator to calculate an average road surface displacement of two or more road surface displacements each obtained by subtracting a vehicle height from the distance to the road surface at each of the two or more points within a range of a tire contact length in a rolling direction of the wheel; and an actuator controller to control an active suspension based on the average road surface displacement so as to stabilize posture of the vehicle body at a predetermined vehicle height, and executes suitable preview control in response to irregularities of the road surface.

### TECHNICAL FIELD

The present invention relates to a suspension control system and a suspension control method.

### BACKGROUND ART

Efforts have been actively made in recent years to provide access to sustainable transportation systems friendly to vulnerable transportation participants, such as the elderly, disabled people, and children. To this end, efforts in research and development have been focused on further improving safety and convenience in transportation through innovations on stable behavior of vehicles.

One of techniques of active suspension control to improve stable behavior of vehicles is preview control to detect displacements of a road surface in front of a vehicle using a preview sensor, and then adjust vertical movement of a vehicle body to travel on the detected road surface, based on vertical acceleration of the vehicle body and the detected displacements of the road surface. Various techniques have been devised to improve control performance of this preview control.

For example, Patent Literature 1 discloses that when a preview sensor is mounted at an acute angle to the ground so as to detect displacements of a road surface in front of a vehicle, preview distances (distances to points where displacements of the road surface are detected) significantly vary due to pitching of the vehicle. Thus, the sum of the preview distance and a traveling distance is used as a preview position, and a displacement of the road surface (control information necessary to control actuator operation) is stored for each preview position, and the displacements of the road surface are retrieved in the order of the preview positions when the actuator operation is controlled.

Additionally, Patent Literature 1 discloses that intervals of the road surface, at which control information necessary to control the actuator operation is stored, is desirably set equal to a tire contact length.

### PRIOR ART LITERATURES

### Patent Literatures

Patent Literature 1: Japanese Patent Application Publication No. 2011-183919

### SUMMARY OF THE INVENTION

### Problem To Be Solved

On another note, according to the technique of Patent Literature 1 related to stable behavior of a vehicle, allowance time for preview control can be set longer than delay time of controlling the actuator even when a vehicle speed is high, so that control performance of preview control does not deteriorate. Additionally, the intervals of the road surface, at which control information necessary to control the actuator operation is stored, being set equal to a tire contact length allows for preventing capacity of storing the control information from being increased.

However, if a range in a displacement of the detected road surface is shorter than the tire contact length, such as with a groove, the tire may run over the road surface to ignore the displacement, but the technique of Patent Literature 1 may execute unnecessary actuator control, based on the detected displacement of the road surface, to deteriorate control performance.

The present invention is intended to solve this problem and provide a suspension control system to execute appropriate preview control in response to irregularities of a road surface. This in turn contributes to advancement in sustainable transportation systems.

### Solution to Problem

In order to solve the above-identified problem, a suspension control system of the present invention includes: a road surface distance detector to use at least one distance sensor mounted on a vehicle body to detect a distance to a road surface from the distance sensor to at least one point on the road surface through which a wheel passes; an average road surface displacement calculator to calculate an average road surface displacement of two or more road surface displacements each obtained by subtracting a vehicle height from the distance to the road surface at each of two or more points within a range of a tire contact length in a rolling direction of the wheel; and an actuator controller to control an active suspension based on the average road surface displacement so as to stabilize posture of the vehicle body at a predetermined vehicle height.

### Advantageous Effects of the Invention

The suspension control system of the present invention suitably executes preview control in response to irregularities of a road surface, to improve riding comfort.

### BRIEF DESCRIPTION OF DRAWINGS

FIG. 1 is a diagram illustrating an overview of a suspension control system;

FIG. 2 is a side view of a structure of a distance sensor being mounted;

FIG. 3 is a diagram illustrating a relationship between road surface displacements at preview points on a road surface R and a tire of a wheel;

FIG. 4A is a chart indicating a relationship between vehicle speed and a tire contact length with a predetermined tire pressure;

FIG. 4B is a chart indicating a relationship between tire pressure and a tire contact length at a predetermined vehicle speed;

FIG. 5 is a diagram illustrating three distance sensors detecting distances to the road surface, when the wheel is viewed from up ahead of the vehicle; and

FIG. 6 is a flowchart of a processing procedure by a preview controller.

### DESCRIPTION OF EMBODIMENTS

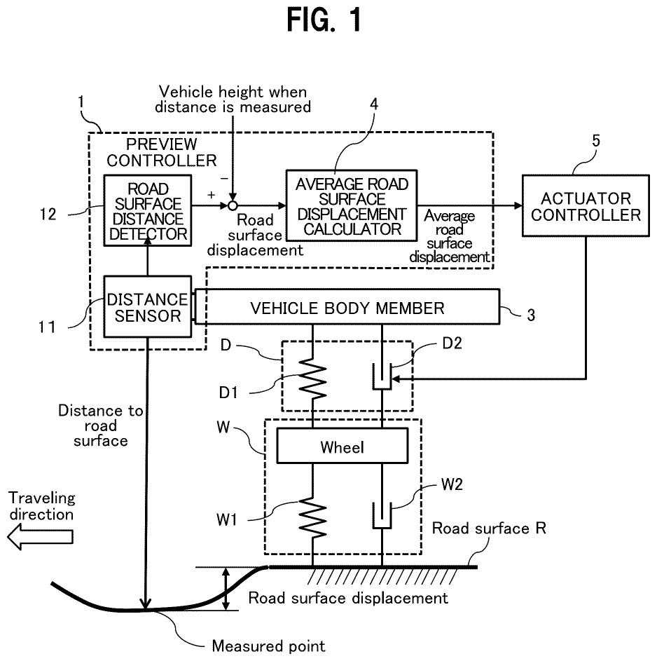

Hereinafter, an embodiment of the present invention is described in detail. FIG. 1 is a diagram illustrating an overview of a suspension control system of an embodiment.

In the suspension control system of the embodiment, an actuator controller 5 controls an active suspension D, based on the skyhook theory or the like, so as to stabilize posture of a vehicle body member 3 at a predetermined vehicle height. At this time, the actuator controller 5 obtains displacements of the road surface in front of a vehicle detected by a preview controller 1 as predicted information, and compensates for a delay in response by the active suspension D, to improve riding comfort.

More in detail, wheels W (left and right front wheels) are provided below the vehicle body member 3 of a vehicle body, and the active suspension D and tires (not shown) of the wheels W absorb irregularities of a road surface R. The actuator controller 5 controls the tire of the wheel W as a vibration model in which a spring W1 and a damper W2 are connected in parallel.

The active suspension D is configured to have a suspension spring D1 and a variable damper D2, which uses a hydraulic actuator to control a damping force or uses an electromagnetic force to control a damping force and a thrust force, arranged in parallel, and is interposed between the vehicle body member 3 and wheel W. The actuator controller 5 controls the variable damper D2 as a controlled unit.

The preview controller 1 includes a distance sensor 11 installed on the vehicle body member 3 and using ultrasonic waves, laser light, or millimeter wave radar to measure distances from itself to measured points on the road surface R, and a road surface distance detector 12 to detect a distance to the road surface in front of the wheels W, based on a value measured by the distance sensor 11. More in detail, the preview controller 1 subtracts a vehicle height (height of the installed distance sensor 11 from a point where the wheel W contacts the ground or a distance of the vehicle body member 3 to a road surface), when the distance is measured, from a value detected by the road surface distance detector 12, to calculate a displacement of the road surface in front of the wheel W. The vehicle height when the distance is measured refers to a value calculated as a control variable by the actuator controller 5.

The preview controller 1 adds a traveling position in a traveling direction of the vehicle to a predicted distance from the point, where the wheel W contacts the ground, to the point where the road surface displacement is measured, which can be calculated from a point of the vehicle body where the distance sensor 11 is mounted, to calculate a predicted position (absolute position of the measured point) on the road surface R, and stores the road surface displacement at each predicted position in a storage unit (not shown).

Note that the predicted distance from the point, where the wheel W contacts the ground, to the point, where the road surface displacement is measured, is set to a value greater than a preview distance obtained from allowance time for preview control and vehicle speed.

An average road surface displacement calculator 4 is a processing unit to calculate an average road surface displacement at the preview positions, based on a ground contact length of the wheel W, although the details are described below. The calculated average road surface displacement is notified to the actuator controller 5, and is used in the preview control as predicted information of the road surface displacement.

The preview controller 1 and actuator controller 5 execute processing periodically. The preview controller 1 detects predicted information of road surface displacements, that is, displacements of the road surface (irregularities of the road surface) in front of the wheel W, which the wheel W passes through after a predetermined time (allowance time), and the actuator controller 5 executes skyhook control for the active suspension D, based on the predicted information of road surface displacements. This improves riding comfort of the vehicle.

In particular, it is preferable that the preview controller 1 uses the distance sensor 11 to detect distances to the road surface so as to obtain predicted information of road surface displacements with a measurement cycle of 1000 Hz (1 cycle/msec) or more, or uses the distance sensor 11 to detect distances to the road surface periodically so as to obtain predicted information of road surface displacements at intervals of 15 to 30 mm.

In the suspension control system of the embodiment, the distance sensor 11 is mounted on the vehicle body member 3, and the road surface distance detector 12, average road surface displacement calculator 4, and actuator controller 5 are implemented in one or more ECUs (Electronic Control Units) of the vehicle. Hereinbelow, a description is given of mounting the distance sensor 11.

A structure of the distance sensor 11 being mounted, described below, is shown in a simplified manner for the purpose of illustration, and is not limited to this embodiment. Note that a description is given with a traveling direction of the vehicle as “front,” a backward direction as “rear,” a vertically upper side as “up,” a vertically lower side as “down,” and a vehicle width direction as “left” and “right.” In addition, as the structure of the vehicle sensor being mounted is bilaterally symmetrical, one (left side) of the left and right sides is mostly described below, and description of the other side (right side) is skipped as appropriate.

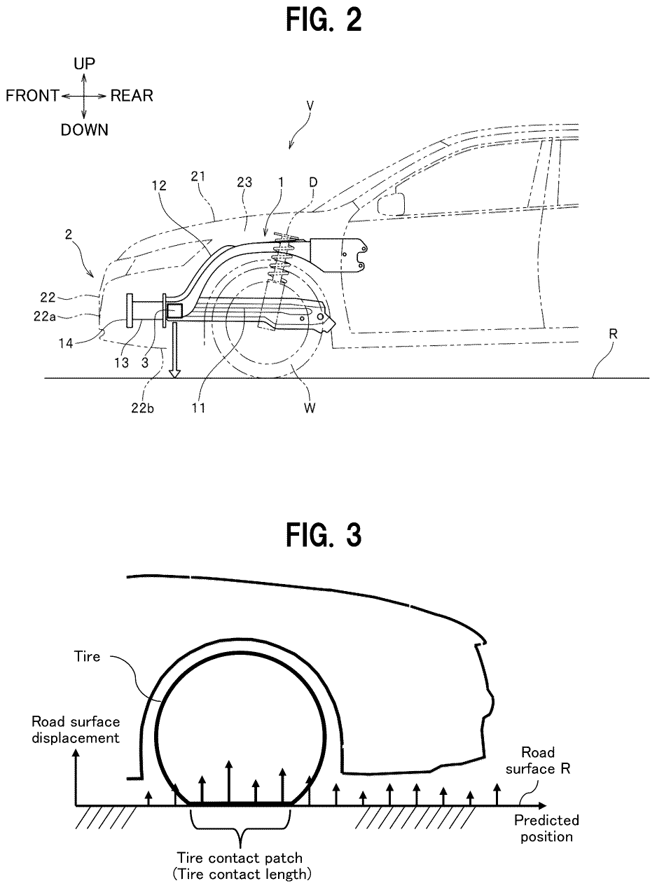

FIG. 2 is a side view of a structure of the distance sensor 11 being mounted. Note that an outline of the vehicle V is indicated by a chain double-dashed line in FIG. 2. As shown in FIG. 2, the distance sensor 11 is fixed to the vehicle body member 3 of the vehicle body.

A vehicle V includes the vehicle body member 3, an exterior member 2 forming an exterior (outer shell) of the vehicle V, and the distance sensor 11 to detect road surface conditions. As described above, a model and a type of the vehicle V is not particularly limited as long as the vehicle includes the vehicle body member 3, exterior member 2, and the distance sensor 11. That is, the vehicle V can be a passenger car, a bus, a truck, a vehicle used for work, or the like.

The vehicle body member 3 supports the exterior member 2 and includes a front side frame 31 (frame member), an upper member 32 (frame member), a bumper beam extension 33, a bumper beam 34 (frame member).

The exterior member 2 includes an engine hood 21, a front bumper 22 (bumper), and a front fender 23. The engine hood 21 is a panel member covering, from above, an area in front of a windshield. The front bumper 22 is located at a front of the vehicle V, and consists of a panel member made of synthetic resin, for example. The front bumper 22 has a front portion 22a provided with an air intake and the like, and a bottom portion 22b extending rearward from a lower end of the front portion 22a. The front fender 23 is a panel member covering a periphery of the wheel W (left front wheel).

The distance sensor 11 is a sensor to detect conditions (road surface conditions) of the road surface R in front of the vehicle V to control the active suspension D of the vehicle V, and is fixed to the upper member 32 in front of the wheels W. More in detail, the distance sensor 11 is mounted on an outer side surface in a vehicle width direction of the upper member 32. Additionally, the distance sensor 11 is located at the front end in a front-rear direction of the upper member 32.

The distance sensor 11 of the present embodiment is configured to detect a distance of itself to the road surface R immediately in front of the wheel W, as indicated by an open arrow. The distance sensor 11 is an infrared distance sensor based on the triangulation principle, a method of converting reflected light intensity of emitted infrared light into a distance, or a method of converting flight time of a laser beam into a distance, and can be appropriately selected from sensors of a radar type, a camera type, a laser type, and the like. The distance sensor 11 is not limited to a single sensor, and may be a combination of two or more types of sensors, such as a camera type and a laser type.

In FIG. 2, the distance sensor 11 is mounted on the vehicle body member 3 so as to measure a distance to the road surface R vertically below the sensor. Assuming that a distance from a grounding point of the wheel W to a road surface vertically below a mounted position of the distance sensor 11 is defined as a predicted distance, the preview controller 1 defines a value obtained by subtracting a height (referred to, herein, as a vehicle height) of the mounted position of the distance sensor 11, from the grounding point of the wheel W, from the distance to the road surface detected by the distance sensor 11, as a road surface displacement at a road surface distanced by the predicted distance.

The distance sensor 11 may be mounted on the vehicle body member 3 so as to measure a distance from vertically below the distance sensor 11 to the road surface R in front of the vehicle. In this case, the product of a distance detected by the distance sensor 11 and the sine of an emission angle to the ground is defined as a distance to the road surface, and the product of the distance detected by the distance sensor 11 and the cosine of the emission angle to the ground added by the distance from the grounding point of the wheel W to the road surface vertically below the mounted position of the distance sensor 11 is defined as a preview distance. It is even better if the emission angle of the distance sensor 11 to the ground is corrected depending on pitching of the vehicle.

Next, the average road surface displacement calculator 4 (see FIG. 1) is described with reference to FIG. 3. FIG. 3 is a diagram illustrating a relationship between the road surface displacements at predicted points on the road surface R and the tire of the wheel W.

The average road surface displacement calculator 4 calculates an average value of road surface displacements, based on road surface displacements at predicted points within a range of a length, in a rolling direction of the wheel, of tire contact patch. This allows for adjusting to variation in stress received by the tire due to random irregularities of the road surface in the contact patch along the length in the rolling direction of the wheel.

In other words, when a concavity (road surface displacement) has a width shorter than a length, in the rolling direction of the wheel, of the tire contact patch, the tire does is not necessarily be deformed to follow the road surface displacement and runs over such a groove when its width is narrow.

Thus, the average road surface displacement calculator 4 corrects the road surface displacements for the contact patch, sensed through previewing, to have road surface displacements for preview control.

More in detail, the average road surface displacement calculator 4 first calculates a preview distance from allowance time for preview control and the vehicle speed, and adds a traveling position in a traveling direction of the vehicle to the preview distance, to calculate a preview position on the road surface R for preview control.

Next, the average road surface displacement calculator 4 uses the preview position calculated above, as the center in a tire contact length, to calculate predicted positions within a range of the tire contact length of the tire contact patch, for recording road surface displacements. Then, the average road surface displacement calculator 4 obtains the road surface displacement at each of the calculated predicted positions.

The average road surface displacement calculator 4 calculates an average value of the obtained road surface displacements, to have an average road surface displacement at the preview position. At this time, the average road surface displacement calculator 4 may simply average road surface displacements, weight the center in the tire contact length to have a weighted average, or weight in a rolling direction of the wheel to have a weighted average.

Note that the average road surface displacement calculator 4 periodically calculates the road surface displacements for preview control, while the vehicle is traveling, and thus it can be argued that moving average of the road surface displacements are calculated based on the tire contact length to calculate the average road surface displacement for preview control.

FIG. 3 illustrates a case where the average road surface displacement calculator 4 calculates the average road surface displacement for preview control, based on the tire contact length in the rolling direction of the wheel, meanwhile the road surface distance detector 12 obtains and averages distances to the road surface in a width direction of the wheel, and uses the average distance to the road surface to calculate road surface displacements at predicted positions, as will be described below. Then, the average road surface displacement calculator 4 may calculate an average road surface displacement from the road surface displacements at the predicted positions within a range of the tire contact length in the rolling direction of the wheel, to have the average road surface displacement for preview control.

In this manner, the suspension control system responds to variation in stress received by the tire due to random irregularities of the road surface in the contact patch along the length in the rolling direction of the wheel, and prevents unnecessary actuator control caused by incorporating irregularities of the road surface, not in contact with the tire, into an average value of distances to the road surface. This allows the suspension control system to suitably control the actuator/suspension.

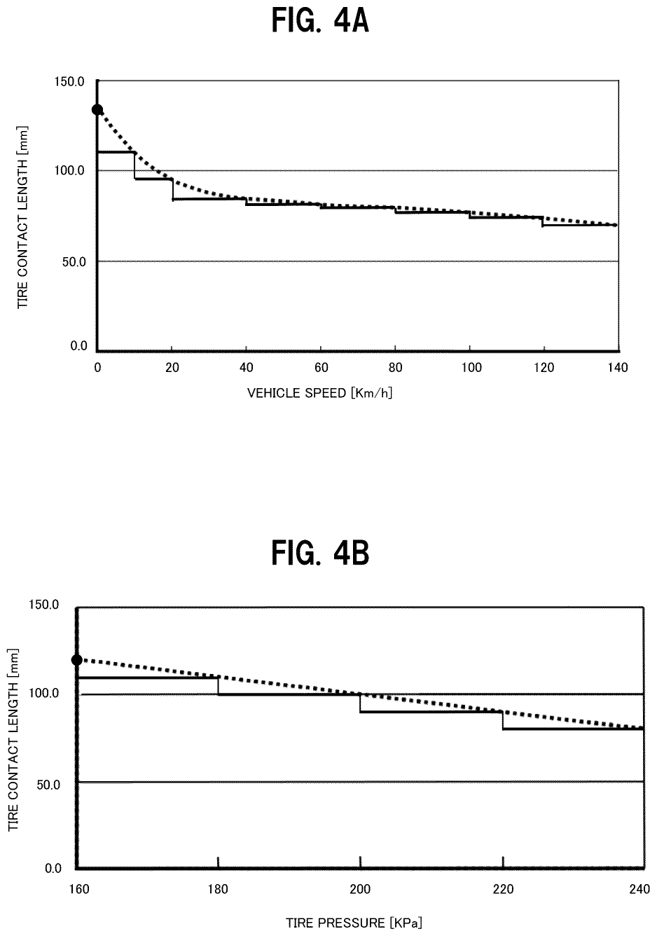

Next, a method of obtaining a tire contact length of the tire contact patch is described with reference to FIGS. 4A and 4B.

Relationships among a ground contact length of a tire as a wheel, vehicle speed, and tire pressure are that the ground contact length depends on a degree of the tire being deformed at around a tire contact point due to stress applied from inside and outside of the tire to the tire contact point, and the higher the vehicle speed (wheel speed) is, the greater a centrifugal force applied from inside to a portion of the tire at around the contact point, resulting in a shorter ground contact length, and the higher the tire pressure is, the less the tire being deformed in response to a reaction force from the road surface, resulting in a shorter ground contact length. Note that if the tire is not deformed at all, the contact point would be a dot or a line.

FIG. 4A is a graph indicating the relationship between vehicle speed and a tire contact length with a predetermined tire pressure (e.g., 220 kPa), and the relationship between vehicle speed and tire contact length is indicated by a dotted line.

The average road surface displacement calculator 4 (see FIG. 1) uses tire pressure detected by an air pressure sensor installed in the vehicle and vehicle speed detected by an ECU of the vehicle to calculate a tire contact length, based on a relational expression, by tire pressure, of the tire contact length, as indicated by the dotted line in FIG. 4A, with respect to the vehicle speed. At this time, assuming that the tire pressure is set to the designated air pressure for the vehicle (vehicle-specific standard air pressure), the vehicle speed may be used to calculate the tire contact length, based on the relational expression, for the designated air pressure for the vehicle, of the tire contact length with respect to the vehicle speed.

In addition, the average road surface displacement calculator 4 may define relational expression, by tire pressure, of the tire contact length, in a multistage form as indicated by a solid line, with respect to predetermined vehicle speed sections, to approximate the relational expression of the tire contact length, as indicated by the dotted line in FIG. 4A, with respect to the vehicle speed and, and use the tire pressure and vehicle speed to calculate the tire contact length.

More in detail, the average road surface displacement calculator 4 is provided with tables, by tire pressure, of the tire contact length for each of the vehicle speed sections, and uses the tire pressure and vehicle speed, with reference to the tables, to calculate the tire contact length. Note that in the case of a vehicle equipped with a system by the name of a TPMS (Tire Pressure Monitoring System) for monitoring tire pressure, the tire pressure can be obtained from the TPMS. There are two types of TPMS: a direct type equipped with an air pressure sensor and configured to directly measure air pressure in a tire air chamber; and an indirect type not equipped with an air pressure sensor and configured to use the wheel speed to estimate tire pressure. The tire pressure may be inputted with a value measured at the time of daily inspection before start of driving the vehicle, instead of a value from the TPMS.

FIG. 4B is a graph indicating the relationship between tire pressure and a tire contact length at a predetermined vehicle speed (e.g., 60 km/h), with the relationship between the tire pressure and the tire contact length indicated by a dotted line.

The average road surface displacement calculator 4 (see FIG. 1) uses the tire pressure detected by the air pressure sensor installed on the vehicle and the vehicle speed detected by the ECU of the vehicle to calculate the tire contact length, based on the relational expression, by vehicle speed, of the tire contact length, as indicated by the dotted line in FIG. 4B, with respect to the tire pressure.

In addition, the average road surface displacement calculator 4 may define relational expression, by vehicle speed, of the tire contact length, as indicated by a solid line, with respect to predetermined tire pressure sections, to approximate the relational expression of the tire contact length, as indicated by the dotted line in FIG. 4B, with respect to the tire pressure and, and use the tire pressure and vehicle speed to calculate the tire contact length.

As described above, the average road surface displacement calculator 4 calculates the tire contact length in the rolling direction of the wheel, based on at least the vehicle speed or tire pressure, and then calculates the average road surface displacement for preview control, based on the tire contact length. That is, the suspension control system of the embodiment has the tire contact length varied in the average road surface displacement calculator 4, based on at least one of the vehicle speed and tire pressure. In particular, as the vehicle speed or tire pressure increases, the tire contact length becomes shorter.

This allows for improving accuracy of calculating the road surface displacement to increase accuracy of controlling the actuator/suspension, as compared to the case where the tire contact length is assumed to be constant.

In addition, the average road surface displacement calculator 4 calculates the tire contact length in a multistage form in the rolling direction of the wheel, based on at least one of the vehicle speed and tire pressure, and then calculates the average road surface displacement for preview control, based on the tire contact length. This allows for simplifying processing in the average road surface displacement calculator 4, to reduce processing load of the average road surface displacement calculator 4. Note that FIGS. 4A and 4B each show a graph in a multistage form, but the graph may be in a different form from a multistage form.

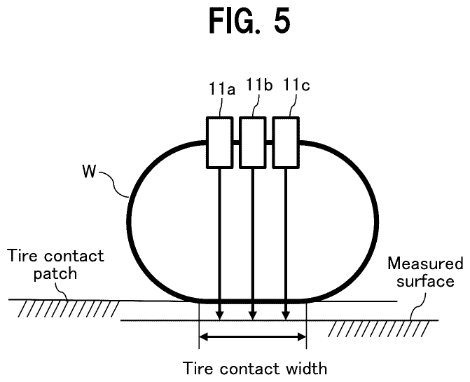

Next, a description is given of a case where two or more distance sensors for determining road surface displacements are provided in the width direction of the wheel. FIG. 5 illustrates the three distance sensors 11 (11a, 11b, 11c) detecting distances to the road surface, when the wheel W is viewed from up ahead of the vehicle.

The wheel W is in contact with the ground on the tire contact patch of the road surface R. As shown in FIG. 1, the distance sensors 11a, 11b, and 11c detect distances to measurement points (front ends of arrows in the drawing) in a measured area in front of the vehicle, in the center in a tire contact width of the wheel W or within a predetermined range of the tire contact width.

The distance sensors 11a, 11b, and 11c detecting the distances to the measurement points allows the preview controller 1 to accurately calculate road surface displacements, even when the load applied to the wheel W varies due to steering angle operation such as cornering, to cause the tire to be deformed to have the tire contact width varied. The feature can also reduce effects of stones and/or litter on the road, as well as irregularities of the road.

More in detail, the road surface distance detector 12 (see FIG. 1) of the preview controller 1 calculates the average value of the distances detected by the distance sensors 11a, 11b, and 11c, to have the distance to the road surface. FIG. 5 shows the three distance sensors 11a, 11b, and 11c, and the description has been given of the case where the average value of the distances to the three measurement points is used as the distance to the road surface, and yet at least distances to two measurement points need to be detected. This allows for improving accuracy of detecting road surface displacement, even when the load applied to the wheel W varies due to steering angle operation such as cornering.

In addition, the road surface distance detector 12 may obtain distances Xa, Xb, and Xc detected by the distance sensors 11a, 11b, and 11c, with weights wa, wb, and wc for the distances by the distance sensors 11a, 11b, and 11c, and calculate (wa×Xa+wb×Xb+wc×Xc)/(wa+wb+wc) to have a distance to the road surface. That is, the road surface distance detector 12 may set the weighted average value of the distances detected by the distance sensors 11a, 11b, and 11c as a distance to the road surface.

Besides, when the road surface distance detector 12 sets the weighted average value as a distance to the road surface, the road surface distance detector 12 may increase the weight wa for a sensor (distance sensor 11a) at a left portion within the ground contact width on the road surface (the left in a direction of the vehicle traveling) and decrease the weight wc for a sensor (distance sensor 11c) at the opposite side, when the vehicle is turning left, to calculate the weighted average value of the distances. When the vehicle is turning right, the weighting is reversed.

That is, the road surface distance detector 12 may calculate a weighted average value as the distance to the road surface, with weights on distances to the road surface in front of the wheel, detected by the distance sensors 11a, 11b, and 11c such that when the vehicle turns, the more a sensor is located on an inner side of the turn, the greater weight is given to the distance for the sensor. This allows for suitably controlling the actuator/suspension so as to more conform to conditions of the road surface through which the wheel actually passes during turning.

The preview controller 1 subtracts a vehicle height, when distance is measured, from the average or weighted average distance to the road surface calculated by the road surface distance detector 12, to calculate a road surface displacement. Then, the preview controller 1 adds the traveling position in the traveling direction of the vehicle to the predicted distance from the grounding point of the wheel W, to the point where the road surface displacement is measured, which can be calculated from the points of the vehicle body where the distance sensors 11a, 11b, and 11c are mounted, to calculate a predicted position (absolute position of the measured point) on the road surface R, and stores the road surface displacement for each predicted position in a storage unit (not shown).

Then, the average road surface displacement calculator 4 calculates an average road surface displacement from the road surface displacements at the predicted positions, based on the tire contact length in the rolling direction of the wheel, to have the average road surface displacement for preview control.

This allows for more suitable control of the actuator/suspension in response to random irregularities of the road surface in the vehicle width direction, as well as more suitable control of the actuator/suspension during turning.

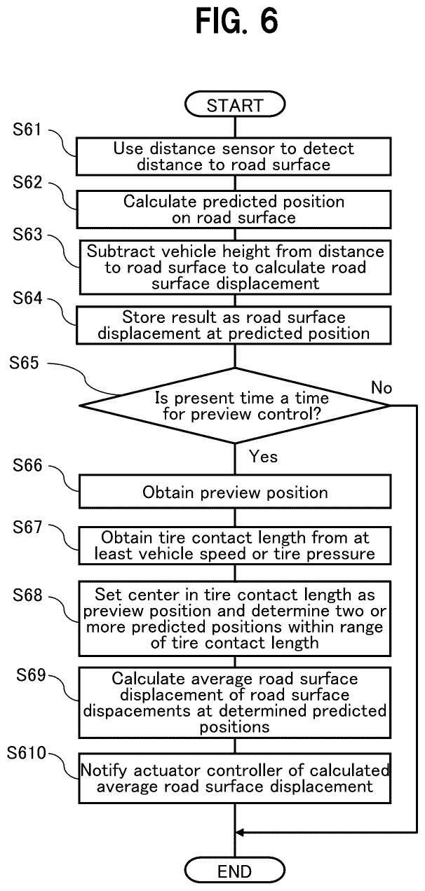

Next, a description is given of a processing procedure of the preview controller 1, with reference to FIG. 6. The preview controller 1 periodically executes the following processing.

In step 61, the road surface distance detector 12 uses the distance sensor 11 to detect a distance to a road surface in front of the wheel W.

In step 62, the preview controller 1 adds a traveling position in the traveling direction of the vehicle to a predicted distance from the grounding point of the wheel W to the point where the road surface displacement is measured, which can be calculated from a point of the vehicle body where the distance sensor 11 is mounted, to calculate a predicted position (position of the measured point) on the road surface R.

In step 63, the preview controller 1 subtracts a vehicle height, when the distance is measured, from the distance to the road surface detected by the road surface distance detector 12, to calculate a road surface displacement in front of the wheel W.

In step 64, the preview controller 1 stores the road surface displacement calculated in step S63 as the road surface displacement at the predicted position calculated in step S62.

In step 65, the preview controller 1 determines whether or not the present time is a time for preview control, and when the present time is a time for preview control (Yes in S65), processing proceeds to step S66. If the present time is not a time for preview control (No in S65), processing ends.

In step 66, the average road surface displacement calculator 4 calculates a preview distance from allowance time for preview control and vehicle speed, and adds a traveling position in the traveling direction of the vehicle to the preview distance, to obtain a preview position on the road surface R for preview control.

In step 67, the average road surface displacement calculator 4 obtains a tire contact length in a rolling direction of the wheel from at least the vehicle speed or tire pressure.

In step 68, the average road surface displacement calculator 4 sets the center in the tire contact length as a preview position, and determines two or more predicted positions within a range of the tire contact length.

In step 69, the average road surface displacement calculator 4 calculates a simple average or a weighted average of the road surface displacements at the two or more predicted positions determined in step S68, to have an average road surface displacement.

In step 610, the average road surface displacement calculator 4 notifies the actuator controller 5 of the average road surface displacement calculated in step S69 as a road surface displacement for preview control.

The present invention is not limited to the above-described embodiment, and can be variously modified in design without departing from the scope thereof. For example, the degree of the suspension being depressed may be measured to correct a tire contact length, depending on the weight (of passengers and loaded luggage).

### LIST OF REFERENCE SIGNS

1, preview controller; 11, distance sensor; 12, road surface distance detector; 2, exterior member; 3, vehicle body member; D, active suspension; D1, suspension spring, D2, variable damper; W, wheel, W1, spring; W2, damper; 4, average road surface displacement calculator; and 5, actuator controller.

1. A suspension control system comprising:
at least one distance sensor mounted on a vehicle body; and
at least one processor configured to executed functions of:
a road surface distance detector to use the sensor to detect a distance to a road surface from the distance sensor to at least one point on the road surface through which a wheel of a vehicle passes;
an average road surface displacement calculator to calculate an average road surface displacement of two or more road surface displacements each obtained by subtracting a vehicle height from the distance to the road surface at each of the two or more points within a range of a tire contact length in a rolling direction of the wheel; and
an actuator controller to control an active suspension based on the average road surface displacement so as to stabilize posture of the vehicle body at a predetermined vehicle height.

2. The suspension control system according to claim 1, wherein
the average road surface displacement calculator calculates the tire contact length in the rolling direction of the wheel, based on at least vehicle speed or tire pressure.

3. The suspension control system according to claim 1,
the average road surface displacement calculator calculates the tire contact length in a multistage form in the rolling direction of the wheel, based on at least one of vehicle speed and tire pressure.

4. The suspension control system according to claim 1, wherein
the road surface distance detector averages distances to the road surface detected by the two or more distance sensors provided in a width direction of the wheel, to have the distance to the road surface from the distance sensor to the point on the road surface through which the wheel passes.

5. The suspension control system according to claim 4, wherein
the road surface distance detector calculates a weighted average value as a distance to the road surface, with weights on distances to the road surface detected by the distance sensors such that when a vehicle turns, the more a sensor is located on an inner side of the turn, the greater weight is given to the distance for the sensor.

6. A suspension control method comprising steps of:
using at least one distance sensor mounted on a vehicle body to detect a distance to a road surface from the distance sensor to at least one point on the road surface through which a wheel passes;
calculating an average road surface displacement of road surface of two or more displacements each obtained by subtracting a vehicle height from the distance to the road surface at each of the two or more points within a range of a tire contact length in a rolling direction of the wheel; and
controlling an active suspension based on the average road surface displacement so as to stabilize posture of the vehicle body at a predetermined vehicle height.
